(19) United States
(12) Patent Application Publication
(10) Pub. No.: US 2021/0063830 A1
(43) Pub. Date: Mar. 4, 2021

(54) ELECTRO-OPTICAL DEVICE AND ELECTRONIC APPARATUS

(71) Applicant: SEIKO EPSON CORPORATION, Tokyo (JP)

(72) Inventor: Satoshi ITO, ENIWA-SHI (JP)

(73) Assignee: SEIKO EPSON CORPORATION, Tokyo (JP)

(21) Appl. No.: 16/999,076

(22) Filed: Aug. 21, 2020

(30) Foreign Application Priority Data
Aug. 26, 2019 (JP) 2019-153544

(51) Int. Cl. G02F 1/1362

(52) U.S. Cl. CPC G02F 1/136227; G02F 1/136286; G03B 21/006; G02F 2201/123; G02F 1/136213

(57) ABSTRACT

An electro-optical device includes a substrate, an electro-optical layer, an insulating layer, a conductive film is disposed between the insulating layer and the electro-optical layer, and that is in contact with the insulating layer, and a conductive portion provided at the insulating layer and coupled to the conductive film, wherein the conductive portion overlaps the conductive film in plan view, a surface of the conductive portion that is in contact with the conductive film is positioned at a first position in a thickness direction of the insulating layer, and a surface of the insulating film that is in contact with the conductive film is positioned at a second position different from the first position in the thickness direction of the insulating layer.

The present application is based on, and claims priority from JP Application Serial Number 2019-153544, filed Aug. 26, 2019, the disclosure of which is hereby incorporated by reference herein in its entirety.

### BACKGROUND

### 1. Technical Field

The present disclosure relates to an electro-optical device and an electronic apparatus.

### 2. Related Art

An electro-optical device such as liquid crystal device used as a light valve of a projector is known. JP-A-2017-120434 discloses a liquid crystal device including a first substrate provided with a pixel electrode and a transistor, a second substrate provided with a common electrode, and a liquid crystal layer provided between the first substrate and the second substrate. The wiring or the like provided on the first substrate has a portion formed along a wall surface of a contact hole of an interlayer insulating film.

In recent years, it is desirable to miniaturize the wiring in order to increase the definition of the electro-optical device. However, when the width of the contact hole is reduced for miniaturization, it is difficult to form the wiring along the wall surface of the contact hole, and the characteristics such as the withstand voltage of the wiring deteriorate. Therefore, in wiring or the like having a portion formed along the wall surface of the contact hole, there is a problem in that miniaturization is difficult while suppressing the deterioration of the characteristics.

### SUMMARY

An aspect of the electro-optical device according to the present disclosure includes includes a substrate, an electro-optical layer, an insulating layer, a conductive film is disposed between the insulating layer and the electro-optical layer, and that is in contact with the insulating layer, and a conductive portion provided at the insulating layer and coupled to the conductive film, wherein the conductive portion overlaps the conductive film in plan view, a surface of the conductive portion that is in contact with the conductive film is positioned at a first position in a thickness direction of the insulating layer, and a surface of the insulating film that is in contact with the conductive film is positioned at a second position different from the first position in the thickness direction of the insulating layer.

### BRIEF DESCRIPTION OF THE DRAWINGS

FIG. 1 is a plan view of an electro-optical device according to a first embodiment.

FIG. 2 is a cross-sectional view taken along line A-A in FIG. 1.

FIG. 3 is an equivalent circuit diagram illustrating an electrical configuration of an element substrate.

FIG. 4 is a cross-sectional view illustrating a part of an element substrate.

FIG. 5 is a plan view illustrating a part of an element substrate.

FIG. 6 is a cross-sectional view illustrating a contact portion coupled to a lower capacitive electrode.

FIG. 7 is a cross-sectional view for describing a method of manufacturing the contact portion.

FIG. 8 is a cross-sectional view for describing a method of manufacturing the contact portion.

FIG. 9 is a cross-sectional view for describing a method of manufacturing the contact portion.

FIG. 10 is a cross-sectional view illustrating a contact portion coupled to a scanning line.

FIG. 11 is a cross-sectional view illustrating a contact portion coupled to a lower capacitive electrode according to a second embodiment.

FIG. 12 is a cross-sectional view illustrating a contact portion coupled to a scanning line.

FIG. 13 is a cross-sectional view illustrating a contact portion coupled to a lower capacitive electrode according to a third embodiment.

FIG. 14 is a plan view illustrating a contact portion according to a modified example.

FIG. 15 is a plan view illustrating a contact portion according to a modified example.

FIG. 16 is a perspective view illustrating a personal computer as an example of an electronic apparatus.

FIG. 17 is a perspective view illustrating a smart phone as an example of an electronic apparatus.

FIG. 18 is a schematic diagram illustrating a projector as an example of an electronic apparatus.

### DESCRIPTION OF EXEMPLARY EMBODIMENTS

Preferred embodiments of the present disclosure will be described below with reference to the accompanying drawings. Note that, in the drawings, dimensions or scales of sections are different from actual dimensions or scales as appropriate, and some of the sections are schematically illustrated to make them easily recognizable. Further, the scope of the present disclosure is not limited to these embodiments unless otherwise stated to limit the present disclosure in the following descriptions.

1. Electro-optical Apparatus

An active matrix liquid crystal device will be described as an example of an electro-optical device of the present disclosure.

### 1A. First Embodiment

1A-1. Basic Configuration

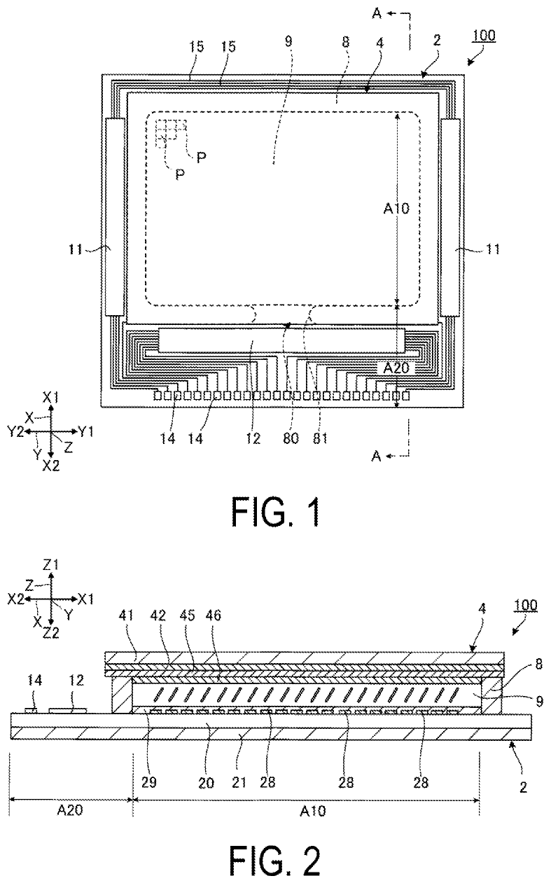

FIG. 1 is a plan view of an electro-optical device 100 according to a first embodiment. FIG. 2 is a cross-sectional view taken along line A-A in FIG. 1. Note that, for convenience of explanation, the description will be made appropriately using an X-axis, a Y-axis, and a Z-axis orthogonal to each other. Further, the direction along the X-axis is referred to as X1 direction, and the direction opposite to the X1 direction is referred to as X2 direction. Similarly, the direction along the Y-axis is referred to as Y1 direction, and the direction opposite to the Y1 direction is referred to as Y2 direction. The direction along the Z-axis is referred to as Z1 direction, and the direction opposite to the Z1 direction is referred to as Z2 direction.

The liquid crystal display device 100 illustrated in FIG. 1 and FIG. 2 is a transmissive-type liquid crystal display device. As illustrated in FIG. 2, the electro-optical device 100 includes an element substrate 2 having translucency, an counter substrate 4 having translucency, a sealing member 8 having a frame shape, and a liquid crystal layer 9. The element substrate 2 is an example of a “first substrate”. The counter substrate 4 is an example of a “second substrate”. The liquid crystal layer 9 is an example of an “electro-optical layer”. The sealing member 8 is disposed between the element substrate 2 and the counter substrate 4. The liquid crystal layer 9 is disposed in a region surrounded by the element substrate 2, the counter substrate 4, and the sealing member 8. The element substrate 2, the liquid crystal layer 9, and the counter substrate 4 are arranged along the Z-axis. A surface of a second substrate 41, described below, including the counter substrate 4 is parallel to the X-Y plane. Hereinafter, viewing from the Z1 direction or the Z2 direction, which is the thickness direction of the element substrate 2, is referred to as “in plan view”.

In the electro-optical device 100 of the present embodiment, the light is incident on the counter substrate 4, for example, and is transmitted through the liquid crystal layer 9 and is emitted from the element substrate 2. Note that, the light may be incident on the element substrate 2 and transmitted through the liquid crystal layer 9 and emitted from the counter substrate 4. The light LL is visible light. The light LL is visible light. The “translucency” refers to transparency to visible light, and means that a transmittance of visible light may be not less than 50%. Further, the liquid crystal display device 100 illustrated in FIG. 1 has a rectangular shape in plan view, but a shape of the liquid crystal display device 100 in plan view is not limited to the rectangular shape, and may be, for example, a round shape and the like.

As illustrated in FIG. 2, the element substrate 2 includes a first base 21, a wiring layer 20, a plurality of pixel electrodes 28, and a first alignment film 29. The first base 21 is formed of a plate having translucency and insulating properties. The wiring layer 20 is disposed between the first substrate 21 and the plurality of pixel electrodes 28. The pixel electrodes 28 have translucency, and is formed of a transparent conductive material such as Indium Tin Oxide (ITO) or Indium Zinc Oxide (IZO). The first alignment film 29 is located closest to the liquid crystal layer 9 side in the element substrate 2, and aligns the liquid crystal molecules of the liquid crystal layer 9. Examples of the constituent material of the first alignment film 29 include polyimide and silicon oxide, for example. Note that, a configuration of the wiring layer 20 will be described below.

As illustrated in FIG. 2, the counter substrate 4 includes a second base 41, an insulating film 42, a common electrode 45, and a second alignment film 46. The second base 41, the insulating film 42, the common electrode 45, and the second alignment film 46 are arranged in this order. The second alignment film 46 is located closest the liquid crystal layer 9 side. The second base 41 is formed from a plate having translucency and insulating properties. The second base 41 is formed of, for example, glass, quartz, or the like. The insulating film 42 is formed of a silicon-based inorganic material having translucency and insulating properties such as silicon oxide. The common electrode 45 is formed of a transparent conductive material such as ITO or IZO. The second alignment film 46 aligns the liquid crystal molecules of the liquid crystal layer 9. Examples of the constituent material of the second alignment film 46 include polyimide and silicon oxide, for example.

The sealing member 8 is formed using an adhesive containing various types of curable resins such as epoxy resin. The sealing member 8 is affixed to each of the element substrate 2 and the counter substrate 4. An injection port 81 for injecting a liquid crystal material containing liquid crystal molecules into the inner side of the sealing member 8 is formed in a portion of the sealing member 8 in the circumferential direction. The injection port 81 is sealed with a sealing material 80 formed of various types of resin materials.

The liquid crystal layer 9 contains liquid crystal molecules having positive or negative dielectric anisotropy. The liquid crystal layer 9 is interposed between the element substrate 2 and the counter substrate 4 such that the liquid crystal molecules are in contact with both the first alignment film 29 and the second alignment film 46. The liquid crystal layer 9 is disposed between the plurality of pixel electrodes 28 and the common electrode 45, and the optical characteristics vary due to the electric field. Specifically, the alignment of the liquid crystal molecules included in the liquid crystal layer 9 varies according to the voltage applied to the liquid crystal layer 9. In other words, the liquid crystal layer 9 enables gray scale display by modulating light according to the applied voltage.

As illustrated in FIG. 1, a plurality of scanning line drive circuits 11, a data line drive circuit 12, and a plurality of external terminals 14 are disposed on a surface of the element substrate 2 on the counter substrate 4 side. The external terminal 14 is coupled with guided wirings 15 guided from each of the scanning line driving circuit 11 and the data line driving circuit 12.

The electro-optical device 100 described above includes a display region A10 in which an image is displayed, and a peripheral region A20 surrounding the display region in plan view. A plurality of pixels P arranged in a matrix pattern are disposed in the display region A10. One pixel electrode 28 is disposed for one pixel P. The scanning line drive circuit 11, the data line drive circuit 12, and the like are disposed in the peripheral region A20.

1A-2. Electrical Configuration

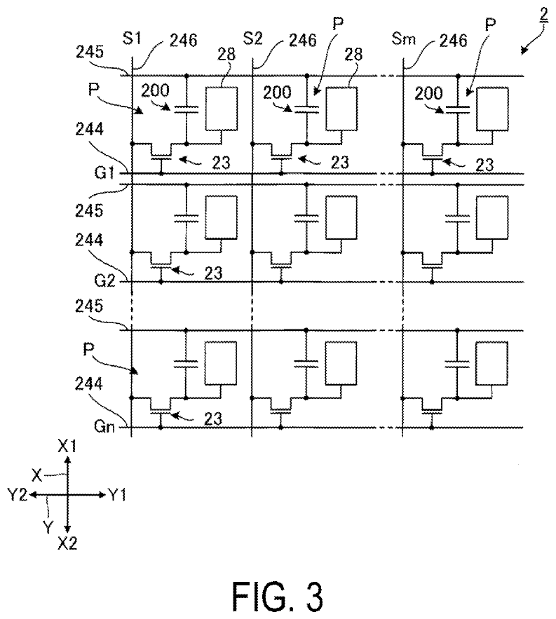

FIG. 3 is an equivalent circuit diagram illustrating an electrical configuration of the element substrate 2. As illustrated in FIG. 3, n pieces of scanning lines 244, m pieces of data lines 246, and n pieces of first constant potential lines 245 as capacitance lines are disposed on the element substrate 2. Note that n and m are each an integer not less than 2.

The n pieces of scanning lines 244 each extend along the Y-axis and are arranged at equal intervals along the X-axis. The scanning line 244 is electrically coupled to a gate of a transistor 23. Further, the n pieces of scanning lines 244 are electrically coupled to the scanning line driving circuit 11 illustrated in FIG. 1. Scanning signals G1, G2, . . . , Gn are line-sequentially supplied from the scanning line driving circuit 11 to the n pieces of scanning lines 244.

The m pieces of data lines 246 illustrated in FIG. 3 each extend along the X-axis and are arranged at equal intervals along the Y-axis. The data line 246 is electrically coupled to a source of the transistor 23. Further, the m pieces of data lines 246 are electrically coupled to the data line driving circuit 12 illustrated in FIG. 1. Image signals S1, S2, . . . , Sm are line-sequentially supplied from the data line driving circuit 12 to the m pieces of data lines 246.

The n pieces of scanning lines 244 and the m pieces of data lines 246 illustrated in FIG. 3 are insulated from each other and are formed in a lattice-like pattern in plan view. A region surrounded by two adjacent scanning lines 244 and two adjacent data lines 246 corresponds to the pixel P. One pixel electrode 28 is provided for one pixel P. One transistor 23 is electrically coupled to one pixel electrode 28. The transistor 23 is a TFT that functions as a switching element, for example.

The n pieces of first constant potential lines 245 each extend along the Y-axis and are arranged at equal intervals along the X-axis. Further, the n pieces of first constant potential lines 245 are insulated from the plurality of data lines 246 and the plurality of scanning lines 244, and are formed apart from these lines. A constant potential such as a ground potential is applied to the first constant potential line 245. Further, a storage capacitor 264 is arranged in parallel to a liquid crystal capacitor, between the first constant potential line 245 and the pixel electrode 28, to prevent leakage of charges held in the liquid crystal capacitor. The storage capacitor 200 is a capacitive element configured to hold the potential of the pixel electrode 28 according to the supplied image signal Sm.

When the scanning signals G1, G2, . . . , Gn become sequentially active and n pieces of scanning lines 244 are sequentially selected, the transistor 23 coupled to the selected scanning line 244 is turned to be on-state. Then, the image signals S1, S2, . . . , Sm having magnitudes commensurate with the gray-scale to be displayed are transmitted, via the m pieces of data lines 246, into the pixels P corresponding to the selected scanning lines 244, and are applied to the pixel electrodes 28. As a result, a voltage according to the gray-scale to be displayed is applied to the liquid crystal capacitor formed between the pixel electrode 28 and the common electrode 33 included in the counter substrate 3 illustrated in FIG. 2, and the alignment of the liquid crystal molecules varies according to the applied voltage. Further, the applied voltage is held by the storage capacitor 200. Such a variation in the alignment of the liquid crystal molecules causes the light to be modulated, to thus enable the gray-scale display.

1A-3. Configuration of Element Substrate 2

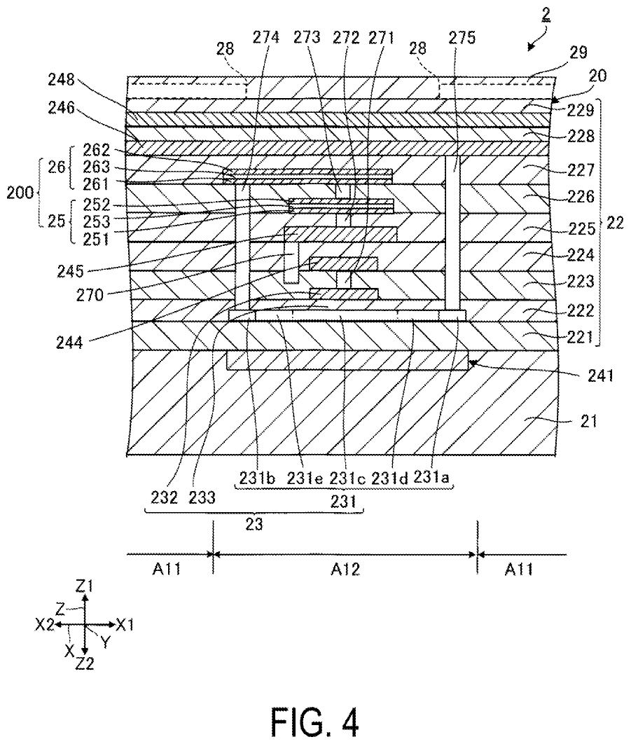

FIG. 4 is a cross-sectional view illustrating a part of the element substrate 2. In the following description, the Z1 direction is described as being upward and the Z2 direction as downward. As illustrated in FIG. 4, a light-shielding body 241 is provided on the first substrate 21 of the element substrate 2. The light-shielding body 241 is provided for each transistor 23. The light-shielding body 241 has light-shielding properties and electrical conductivity. In the following description, light-shielding property refers to a light-shielding property with respect to visible light, and specifically means that a transmittance of visible light is not greater than 10%. Note that, the light-shielding body 241 is disposed in a recess provided in the first substrate 21. Examples of the constituent material of the light-shielding body 241 include metals such as tungsten (W), titanium (Ti), chromium (Cr), iron (Fe), and aluminum (Al), metal nitrides, and metal silicides. Among these, it is preferable to use tungsten. Tungsten has excellent heat resistance, thus, by using tungsten, the light shield 241 can particularly effectively prevent light from entering the transistor 23.

A wiring layer 20 is disposed on the light-shielding body 241. The wiring layer 20 includes the transistor 23, the scanning line 244, the first constant potential line 245, the storage capacitor 200, the data line 246, and a second constant potential line 248. Furthermore, the wiring layer 20 includes an insulator 22 having insulating properties and light-transmissive properties. The insulator 22 includes interlayer insulating films 221, 222, 223, 224, 225, 226, 227, 228 and 229. The interlayer insulating films 221, 222, 223, 224, 225, 226, 227, 228 and 229 are arranged in this order from the first substrate 21 toward the pixel electrode 28. The interlayer insulating films 221 to 229 are each formed of a silicon oxide film formed by, for example, thermal oxidation or CVD (chemical vapor deposition) method. The wirings and electrodes included in the wiring layer 20 are disposed between the films that constitute the insulator 22 while being in contact with the films.

The interlayer insulating film 221 is disposed on the first substrate 21 to cover the light-shielding body 241. The transistor 23 is disposed on the interlayer insulating film 221. The transistor 23 includes a semiconductor layer 231, a gate electrode 232, and a gate insulating film 233. The semiconductor layer 231 is disposed between the interlayer insulating film 222 and the interlayer insulating film 223. The semiconductor layer 231 includes a source region 231a, a drain region 231b, a channel region 231c, a first Lightly Doped Drain (LDD) region 231d, and a second LDD region 231e. The semiconductor layer 231 is formed, for example, by depositing polysilicon, and the region excluding the channel region 231c is doped with an impurity that enhances the conductivity. The impurity concentration in the first LDD region 231d and the second LDD region 231e is lower than the impurity concentration in the source region 231a and the drain region 231b. Note that, at least one of the first LDD region 231d and the second LDD region 231e may be omitted.

The gate electrode 232 is disposed between the interlayer insulating film 222 and the interlayer insulating film 223. The gate electrode 232 overlaps the channel region 231c of the semiconductor layer 231 when viewed from the Z1 direction. The gate electrode 232 is formed, for example, by doping polysilion with an impurity that enhances the conductivity. Note that, the gate electrode 232 may be formed using a material having conductivity such as metal, metal silicide, and metal compound. Further, the gate insulating film 233 is interposed between the gate electrode 232 and the channel region 231c. The gate insulating film 233 is formed of, for example, silicon oxide formed by thermal oxidation or CVD method.

The scanning line 244 is disposed between the interlayer insulating film 223 and the interlayer insulating film 224. The scanning line 244 is coupled to the gate electrode 232 via a contact portion 271 that penetrates the interlayer insulating film 223. Note that in the present embodiment, the gate electrode 232 and the light-shielding body 241 are insulated, but these may be electrically coupled. In this case, the light-shielding body 241 can be used as a back gate.

The first constant potential line 245 is disposed between the interlayer insulating film 224 and the interlayer insulating film 225. A shield portion 270 is coupled to the first constant potential line 245. The shield portion 270 is disposed to penetrate the interlayer insulating film 224 and reach an intermediate position in the thickness direction of the interlayer insulating film 223. Further, the shield portion 270 overlaps the second LDD region 231e when viewed from the Z1 direction. The shield portion 270 functions as a shield that suppresses the effect of the leakage field from the scanning line 244 on the transistor 23. Additionally, the shield portion 270 functions as a light-shielding portion of the semiconductor layer 231. A constant potential is supplied to the shield portion 270 from the first constant potential line 245.

The storage capacitor 200 is disposed on the interlayer insulating film 225. The storage capacitor 200 includes a first capacitor 25 and a second capacitor 26. The first capacitor 25 is disposed between the interlayer insulating film 225 and the interlayer insulating film 226. The first capacitor 25 includes a lower capacitive electrode 251, an upper capacitive electrode 252, and a dielectric layer 253 disposed between the lower capacitive electrode 251 and the upper capacitive electrode 252. The lower capacitive electrode 251 is coupled to the first constant potential line 245 via a contact portion 272 that penetrates the interlayer insulating film 225. The second capacitor 26 is disposed between the interlayer insulating film 226 and the interlayer insulating film 227. The second capacitor 26 includes a lower capacitive electrode 261, an upper capacitive electrode 262, and a dielectric layer 263 disposed between the lower capacitive electrode 261 and the upper capacitive electrode 262. The lower capacitive electrode 261 is coupled to the upper capacitive electrode 252 of the first capacitor 25 via a contact portion 273 that penetrates the interlayer insulating film 226. The lower capacitive electrode 261 is electrically coupled to the drain region 231b of the transistor 23 via a contact portion 274 that penetrates the interlayer insulating films 222 to 226. The upper capacitive electrode 252 of the first capacitor 25 is electrically coupled to the pixel electrode 28 disposed on the wiring layer 20 via a contact portion (not illustrated) or the like.

The data line 246 is disposed between the interlayer insulating film 227 and the interlayer insulating film 228. The data line 246 contacts the interlayer insulating film 227 and the interlayer insulating film 228. The data line 246 is electrically coupled to the source region 231a of the transistor 23 via a contact portion 275 that penetrates the interlayer insulating films 222 to 227. The second constant potential line 248 is disposed between the interlayer insulating film 228 and the interlayer insulating film 229. The second constant potential line 248 is electrically coupled to the upper capacitive electrode 262 of the second capacitor 26 via a contact portion (not illustrated) or the like. As with the first constant potential line 245, a constant potential such as, for example, a ground potential is applied to the second constant potential line 248. The constant potential supplied to the first constant potential line 245 and the constant potential supplied to the second constant potential line 248 are the same potential.

The lower capacitive electrode 251, the upper capacitive electrode 252, the lower capacitive electrode 261, and the upper capacitive electrode 262 are configured by, for example, a titanium nitride film. The wiring of the scanning line 244, the first constant potential line 245, the data line 246, the second constant potential line 248, and the like are configured by a layered body of an aluminum film and a titanium nitride film, for example. By including the aluminum film, resistance can be reduced compared to a case in which only a titanium nitride film is used. Note that, each of these electrodes or wirings may be formed of materials other than the materials described above. For example, each of these electrodes or wirings may be formed of metals such as tungsten (W), titanium (Ti), chromium (Cr), iron, and aluminum (Al), metal nitrides, metal silicide, and the like.

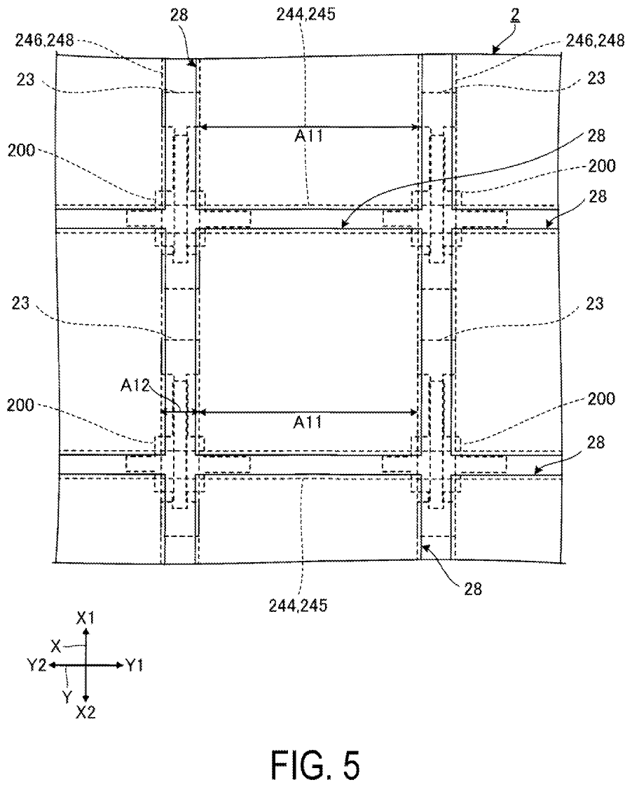

FIG. 5 is a plan view illustrating a part of the element substrate 2. As illustrated in FIG. 5, the element substrate 2 includes a plurality of light-transmitting regions A11 through which light is transmitted and a wiring region A12 that blocks light. The plurality of light-transmissive regions A11 are arranged in a matrix pattern and each has a substantially quadrangular shape when viewed from the Z1 direction. The pixel electrode 28 is provided in each of the light-transmitting regions A11. The wiring region A12 is formed in a lattice shape when viewed from the Z1 direction, and surrounds the light-transmitting region A11. The transistor 23, the storage capacity 200, the scanning line 244, the data line 246, the first constant potential line 245, and the plurality of second constant potential lines 248 are provided in the wiring region A12. The plurality of scanning lines 244 and the plurality of data lines 246 are formed in a lattice shape when viewed from the Z1 direction. The plurality of first constant potential lines 245 and the plurality of second constant potential lines 248 are formed in a lattice shape when viewed from the Z1 direction. The transistor 23 and the storage capacitor 200 are disposed at intersecting position of the scanning line 244 and the data line 246.

Further, the contact portions 271 to 275 and the shield portion 270 illustrated in FIG. 4 are provided in the wiring region A12. In other words, the contact portions 271 to 275 and the shield portion 270 are disposed between two adjacent pixel electrodes 28 when viewed from the Z1 direction. Note that, the two adjacent pixel electrodes 28 are any two pixel electrodes 28 that are adjacent to each other along X-axis, Y-axis, or an axis intersecting both the X-axis and the Y-axis in the X-Y plane. When any one of the plurality of pixel electrodes 28 is referred to as a “first pixel electrode”, and one pixel electrode 28 adjacent thereto is referred to as a “second pixel electrode”, the contact portions 271 to 275 and the shield portion 270 are provided between the “first pixel electrode” and the “second pixel electrode”.

1A-4. Contact Portion

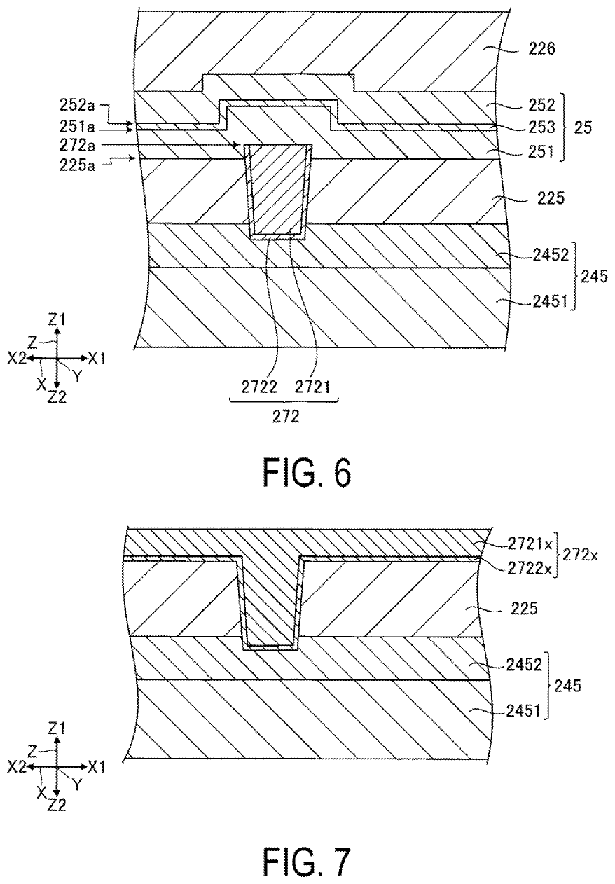

FIG. 6 is a cross-sectional view illustrating the contact portion 272 coupled to the lower capacitive electrode 251. Note that, the contact portions 272 to 274 have the same configuration, thus the contact portion 272 will be described below as a representative. In the following description, the contact portion 272 corresponds to a “conductive portion”, the interlayer insulating film 225 corresponds to an “insulating layer”, the first constant potential line 245 corresponds to a “second conductive film”, and the lower capacitive electrode 251 of the first capacitor 25 corresponds to a “conductive film”. Thus, the lower capacitive electrode 251 corresponds to a “first conductive film”. The lower capacitive electrode 251 is located between the interlayer insulating film 225 and the liquid crystal layer 9 described above.

As illustrated in FIG. 6, the contact portion 272 is provided on the interlayer insulating film 225. Specifically, the contact portion 272 is provided to fill in a contact hole, which is a through-hole formed in the interlayer insulating film 225. One end of the contact portion 272 is coupled to the first constant potential line 245, and the other end is coupled to the lower capacitive electrode 251. In the example illustrated in FIG. 6, the first constant potential line 245 is configured by a layered body of an aluminum film 2451 and a titanium nitride film 2452. The titanium nitride film 2452 contacts the contact portion 272. Note that the contact portion 272 may penetrate the titanium nitride film 2452 and contact the aluminum film 2451.

The contact portion 272 is configured by a layered body of a second layer 2722 and a first layer 2721. The first layer 2721 contains tungsten. Tungsten is a material that has an excellent heat resistance and a high aspect ratio, and is easily embedded in contact hole. As a result, when the first layer 2721 contains tungsten, the occurrence of defects in the contact portion 272 can be suppressed. Further, the second layer 2722 is formed of a material different from the first layer 2721, and is located between the first layer 2721 and the interlayer insulating film 225. The second layer 2722 is formed of a material different from the first layer 2721, thus, a function corresponding to the material or the like of the second layer 2722 is imparted to the contact portion 271 compared to a case where the second layer 2722 is configured by only the first layer 2721. For example, the second layer 2722 is provided to enhance the adhesion of the first layer 2721 to the interlayer insulating film 225. For example, the second layer 2722 contains tungsten nitride (WN), titanium nitride (TiN), tungsten silicide (WSi), and the like. In particular, by containing tungsten nitride, the adhesion between the first layer 2721 and the interlayer insulating film 225 can be enhanced.

The contact portion 272 is formed of a material different from the material forming the lower capacitive electrode 251, and overlaps the lower capacitive electrode 251 when viewed from the Z1 direction. In other words, the contact portion 272 is covered by the lower capacitive electrode 251 of a material different from the material of the contact portion 272. By providing such a contact portion 272, the lower capacitive electrode 251 need not be provided along the wall surface of the contact hole as in the related art. As a result, the lower capacitive electrode 251 can be miniaturized, and the lower capacitive electrode 251 can be formed with a sufficient thickness, which makes it possible to suppress a decrease in withstand voltage.

As illustrated in FIG. 6, a surface 272a of the contact portion 272 that contacts the lower capacitive electrode 251 differs in position in the Z1 direction from a surface 225a of the interlayer insulating film 225 that contacts the lower capacitive electrode 251. The surface 225a is particularly a portion of the interlayer insulating film 225 that contacts the interlayer insulating film 226. In the present embodiment, the surface 272a of the contact portion 272 is located in the Z1 direction with respect to the surface 225a of the interlayer insulating film 225. In other words, the contact portion 272 includes a portion protruding in the Z1 direction from the interlayer insulating film 225. Thus, a surface 251a of the lower capacitive electrode 251 provided on the interlayer insulating film 225 and the contact portion 272 has recesses or protrusions corresponding to differences in positions in the Z1 direction between the surface 225a of the interlayer insulating film 225 and the surface 272a of the contact portion 272. As a result, the area of the surface 251a can be increased compared to a case where the surface 251a is a flat surface. Note that the surface 251a is a surface opposite to the interlayer insulating film 225 of the lower capacitive electrode 251 and is a surface that contacts the dielectric layer 253. Similarly, a surface 252a of the upper capacitive electrode 252 also has recesses or protrusions. As a result, the area of the surface 252a can be increased. Note that the surface 252a is a surface of the upper capacitive electrode 252 that contacts the dielectric layer 253. As described above, the retention capacity of the first capacitor 25 can be increased by increasing the area of each of the surfaces 251a and 252a. Thus, by providing the contact portion 272, the first capacitor 25 can be miniaturized while suppressing a decrease in the retention capacity of the first capacitor 25. Thus, even if the first capacitor 25 is not formed along the wall surface of the contact hole, it is possible to increase the retention capacity.

The contact portion 272 overlaps the first constant potential line 245 when viewed from the Z1 direction, and is coupled to the first constant potential line 245. In other words, the contact portion 272 is used for connecting the first constant potential line 245 and the lower capacitive electrode 251. The contact portion 272 is formed to fill the contact hole, thus, the decrease in withstand voltage is suppressed even if the width of the contact hole is smaller than the related art. Therefore, by connecting the first constant potential line 245 and the lower capacitive electrode 251 by the contact portion 272, connection failure or the like between the first constant potential line 245 and the lower capacitive electrode 251 is suppressed.

In addition, as described above, the contact portion 272 is disposed between two adjacent pixel electrodes 28 illustrated in FIG. 4, when viewed from the Z1 direction. In other words, the contact portion 272 does not overlap with the pixel electrode 28 when viewed from the Z1 direction. As described above, the contact portion 272 is provided to fill the contact hole of the interlayer insulating film 225. As a result, an increase in the area of the wiring region A12 can be suppressed, and the element substrate 2 can be made higher in definition while preventing a reduction in the opening ratio of the element substrate 2.

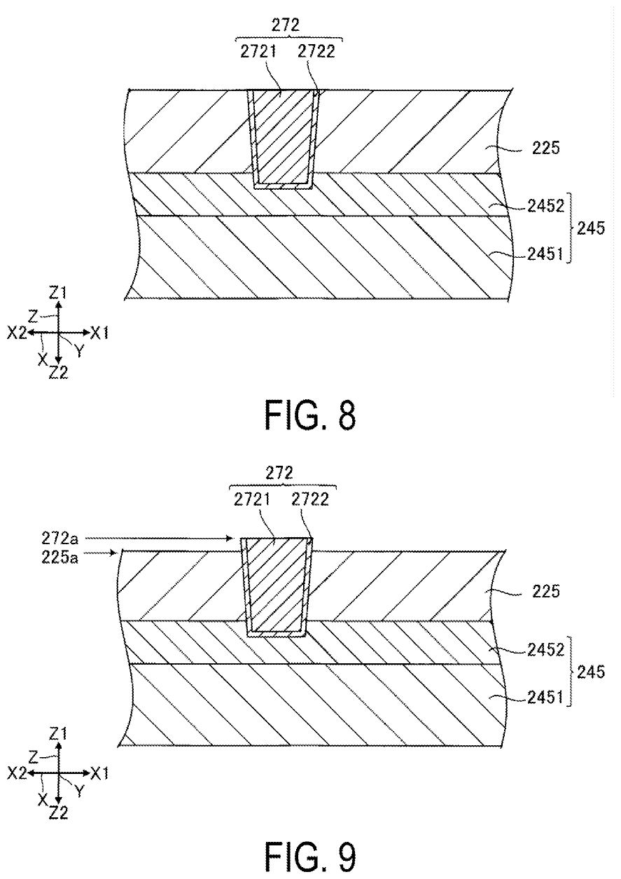

FIG. 7, FIG. 8, and FIG. 9 are cross-sectional views for describing a method of manufacturing the contact portion 272. The contact portion 272 is formed by using a damascene method or the like. Specifically, first, a contact hole is formed in the interlayer insulating film 225, and a conductive material layer 272x illustrated in FIG. 7 is formed by embedding tungsten or the like into the contact hole. The conductive material layer 272x is a layered body of a first material layer 2721x containing tungsten, for example, and a second material layer 2722x formed of a material different from the first material layer 2721x.

Next, as illustrated in FIG. 8, the contact portion 272 is formed by performing a polishing flattening treatment such as Chemical Mechanical Polishing (CMP) on the conductive material layer 272x. In the present embodiment, for example, a polishing liquid or the like is selected according to the materials and the like of the first material layer 2721x and the second material layer 2722x, and a flattening treatment is performed so that the positions of the surfaces of the first material layer 2721x and the second material layer 2722x in Z1 direction are substantially the same.

Next, as illustrated in FIG. 9, a part of the interlayer insulating film 225 is removed by wet etching or the like. As a result, the contact portion 272 protrudes in the Z1 direction from the interlayer insulating film 225. In the wet etching, an etchant that hardly removes the contact portion 272 and easily removes the interlayer insulating film 223 is used. For example, a fluorine-based etchant such as BHF (buffered hydrofluoric acid) or DHF (dilute hydrofluoric acid) is used. According to this method, the contact portion 272 having a portion protruding in the Z1 direction from the interlayer insulating film 225 can be formed without excessively increasing the number of processes.

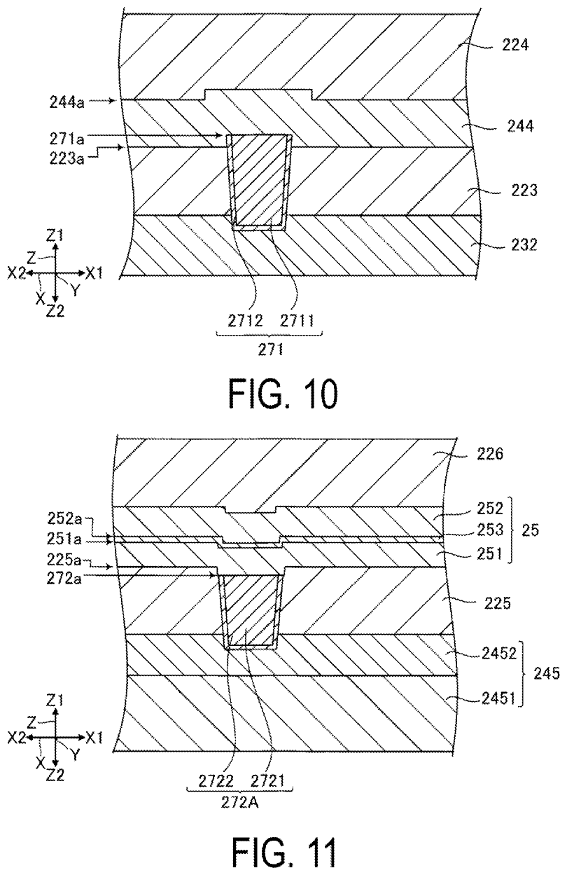

FIG. 10 is a cross-sectional view illustrating the contact portion 271 coupled to the scanning line 244. Note that the contact portions 271 and 275 have the same configuration, thus the contact portion 271 will be described below as a representative. Furthermore, for the contact portion 271, the same descriptions as those of the contact portion 272 described above will be appropriately omitted. In the following description, the contact portion 271 corresponds to a “conductive portion”, the interlayer insulating film 223 corresponds to an “insulating layer”, the gate electrode 232 corresponds to a “second conductive film”, and the scanning line 244 corresponds to a “conductive film”. Thus, the scanning line 244 corresponds to a “first conductive film”. The scanning line 244 is located between the interlayer insulating film 223 and the liquid crystal layer 9 described above.

As illustrated in FIG. 10, the contact portion 271 is provided on the interlayer insulating film 223. Specifically, the contact portion 271 is provided to fill the contact hole formed in the interlayer insulating film 223. One end of the contact portion 271 is coupled to the scanning line 244, and the other end is coupled to the gate electrode 232. Similar to the contact portion 272, the contact portion 271 includes a first layer 2711 containing tungsten, for example, and a second layer 2712 formed of a material different from the first layer 2711.

The contact portion 271 is formed of a material different from the material forming the scanning line 244, and overlaps the scanning line 244 when viewed from the Z1 direction. By providing such a contact portion 271, the scanning line 244 need not to have a portion along the wall surface of the contact hole as in the related art. Therefore, the scanning line 244 can be miniaturized, and the scanning line 244 can be formed with a sufficient thickness, which makes it possible to suppress a decrease in withstand voltage.

As illustrated in FIG. 10, a surface 271a of the contact portion 271 that contacts the scanning line 244 differs in position in the Z1 direction from a surface 223a of the interlayer insulating film 223 that contacts the scanning line 244. The surface 223a is particularly a portion of the interlayer insulating film 223 that contacts the interlayer insulating film 224. In the present embodiment, the surface 271a of the contact portion 271 is located in the Z1 direction with respect to the surface 223a of the interlayer insulating film 223. In other words, the contact portion 271 includes a portion protruding in the Z1 direction from the interlayer insulating film 223. Thus, the contact area of the contact portion 271 with respect to the scanning line 244 can be increased compared to a case where the surface 271a of the contact portion 271 is located on the same plane with the surface 223a of the interlayer insulating film 223. Therefore, resistance between the scanning line 244 and the contact portion 271 can be reduced. Thus, the scanning line 244 can be miniaturized while suppressing a decrease in withstand voltage and an increase in the resistance of the scanning line 244. In addition, a surface 244a of the scanning line 244 has recesses or protrusions corresponding to differences in positions in the Z1 direction between the surface 223a of the interlayer insulating film 223 and the surface 271a of the contact portion 271. It can be considered that the cross-sectional area of the scanning line 244 increases as the contact portion 271 protrudes with respect to the surface 223a of the interlayer insulating film 223. Thus, the resistance of the scanning line 244 can be reduced.

The shield portion 270 illustrated in FIG. 4 is also the same as the contact portion 272 described above. Hereinafter, for the descriptions of the shield portion 270, the same descriptions as those of the contact portion 272 described above will be appropriately omitted. When the shield portion 270 is a “conductive portion”, the interlayer insulating films 223 and 224 correspond to “insulating layers”, and the first constant potential lines 245 correspond to “conductive films”. The first constant potential line 245 is located between the interlayer insulating film 224 and the liquid crystal layer 9 described above.

The shield portion 270 illustrated in FIG. 4 is provided to fill a recessed portion formed in the interlayer insulating films 223 and 224, and overlaps the first constant potential line 245 when viewed from the Z1 direction. With the shield portion 270 having such a configuration, the first constant potential line 245 can be miniaturized even if the shield portion 270 coupled to the first constant potential line 245 is provided.

Further, although not illustrated, the contact portion coupled to the pixel electrode 28 may have the same configuration as the contact portion 271.

### 1B. Second Embodiment

A second embodiment will be described. Note that, in the following embodiments, a sign used in the description of the first embodiment is used for the same element as that of the first embodiment, and each detailed description thereof will be appropriately omitted.

FIG. 11 is a cross-sectional view illustrating a contact portion 272A coupled to the lower capacitive electrode 251 according to the second embodiment. A surface 272a of the contact portion 272A is located in the Z2 direction with respect to the surface 225a of the interlayer insulating film 225. In other words, the contact portion 272A includes a portion recessed in the Z2 direction with respect to the surface 225a of the interlayer insulating film 225. Thus, in the present embodiment as well, similar to the first embodiment, the surface 251a of the lower capacitive electrode 251 has recesses or protrusions corresponding to differences in positions in the Z1 direction of the surface 272a and the surface 225a. Due to the surface 251a having unevenness, the area of the surface 251a can be increased compared to a case where the surface 251a is a flat surface. In addition, the surface 252a of the upper capacitive electrode 252 also has unevenness, thus the area of the surface 252a can be increased. Thus, in the present embodiment as well, similar to the first embodiment, the retention capacity of the first capacitor 25 can be increased. Thus, the first capacitor 25 can be miniaturized while suppressing a decrease in the retention capacity of the first capacitor 25.

The contact portion 272A illustrated in FIG. 11 is formed in the same manner as the contact portion 272 according to the first embodiment. However, for example, the polishing liquid or etchant is different from the first embodiment. For example, the flattening treatment is performed under conditions where the contact portion 272A is more easily polished than the interlayer insulating film 225 using particles larger than the particles contained in the polishing liquid used in the first embodiment. Note that in the present embodiment, the wet etching in the first embodiment may be omitted as appropriate.

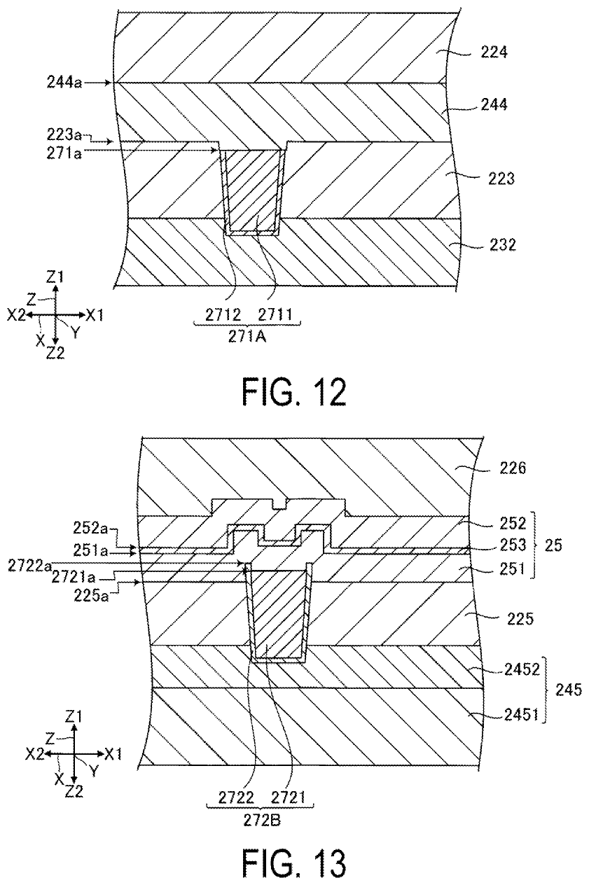

FIG. 12 is a cross-sectional view illustrating the contact portion 271A coupled to the scanning line 244. A surface 271a of the contact portion 271A is located in the Z2 direction with respect to the surface 223a of the interlayer insulating film 223. In other words, the contact portion 271A includes a portion recessed in the Z2 direction with respect to the surface 223a of the interlayer insulating film 223. In addition, in the present embodiment, the surface 244a of the scanning line 244 is a flat surface. The scanning line 244 has a sufficient thickness such that the surface 244a of the scanning line 244 is a flat surface. As a result, the cross-sectional area of the scanning line 244 can be increased by the contact portion 271A being recessed with respect to the surface 223a. Thus, the scanning line 244 can be miniaturized while suppressing an increase in resistance of the scanning line 244.

Note that, although not illustrated, the positions in the Z1 direction of the contact portions 273 to 275 and the shield portion 270 in the second embodiment are the same as the positions in the Z1 direction of the contact portion 272 according to the present embodiment. With the contact portions 271 to 275 and the shield portion 270 in the second embodiment, similar to the first embodiment, wiring and the like can be miniaturized while reducing characteristics such as withstand voltage.

### 1C. Third Embodiment

A third embodiment will be described. Note that, in the following embodiments, a sign used in the description of the first embodiment is used for the same element as that of the first embodiment, and each detailed description thereof will be appropriately omitted.

FIG. 13 is a cross-sectional view illustrating a contact portion 272B coupled to the lower capacitive electrode 251 according to the third embodiment. For a first layer 2721 and a second layer 2722 included in the contact portion 272B illustrated in FIG. 13, the position of a surface 2721a of the first layer 2721 that contacts the lower capacitive electrode 251 and the position of a surface 2722a of the second layer 2722 that contacts the lower capacitive electrode 251 are different in the Z1 direction. In addition, each of the surface 2721a and the surface 2722a is different from the surface 225a of the interlayer insulating film 225 in the Z1 direction. In the present embodiment, the portion of the surface 2722a located most in the Z1 direction is located between the portion of the surface 2721a located most in the Z1 direction and the surface 225a. The contact portion 272b can also form recesses or protrusions on the surface 251a of the lower capacitive electrode 251. Similarly, recesses or protrusions can be formed on the surface 252a of the upper capacitive electrode 252. As a result, the first capacitor 25 can be miniaturized while increasing the retention capacity of the first capacitor 25.

The contact portion 272B illustrated in FIG. 13 is formed in the same manner as the contact portion 272 according to the first embodiment. However, for example, the polishing liquid or etchant is different from the first embodiment. For example, the flattening treatment is performed using a polishing liquid that is more likely to polish the first layer 2711 than the second layer 2722.

Note that, although not illustrated, the positions in the Z1 direction of the contact portions 271, 273 to 275 and the shield portion 270 in the third embodiment are the same as the positions in the Z1 direction of the contact portion 272 according to the present embodiment. With the contact portions 271 to 275 and the shield portion 270 of the third embodiment, similar to the first embodiment, wiring and the like can be miniaturized while reducing characteristics such as withstand voltage.

### 1D. Modified Example

Each of the embodiments exemplified in the above can be variously modified. Specific modification aspects applied to each of the embodiments described above are exemplified below. Two or more modes freely selected from exemplifications below can be appropriately used in combination as long as mutual contradiction does not arise.

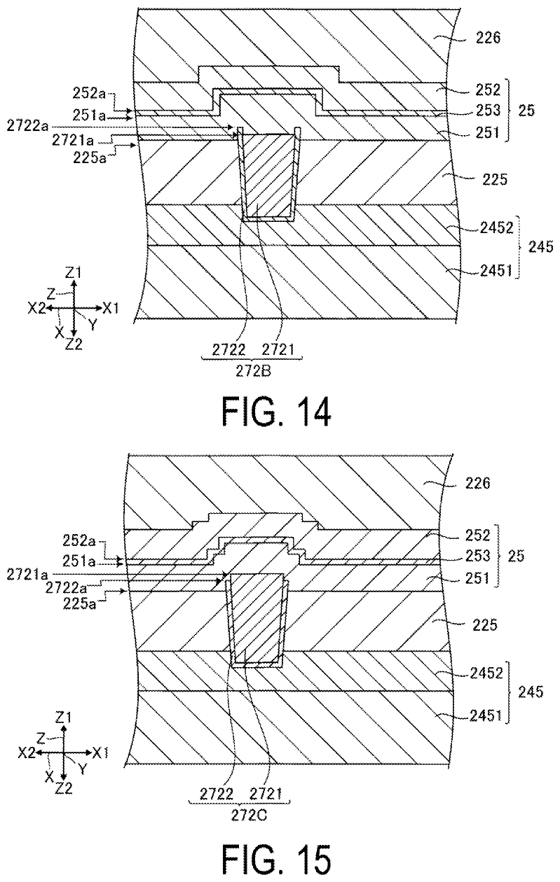

FIG. 14 is a plan view illustrating a contact portion 272B according to a modified example. In the third embodiment, the surface 251a of the lower capacitive electrode 251 has recesses or protrusions corresponding to differences in positions in the Z1 direction between the surface 2721a of the first layer 2711 and the surface 2722a of the second layer 2722. However, the surface 251a may not have recesses or protrusions corresponding to the surface 2721a and the surface 2722a.

FIG. 15 is a plan view illustrating a contact portion 272C according to a modified example. As illustrated in FIG. 14, in the Z1 direction, the surface 2722a may be located between the surface 2721a and the surface 225a. In particular, a portion of the surface 2722a that is located most in the Z1 direction may be located between the portion of the surface 2721a that is located most in the Z1 direction and the surface 225a.

In the third embodiment, the surface 2721a and the surface 2722a are located in the Z1 direction with respect to the surface 225a. However, the surface 2721a and the surface 2722a may be located in the Z2 direction with respect to the surface 225a. In addition, any one of the surface 2721a and the surface 2722a may be located in the Z1 direction with respect to the surface 225a, and the other may be located in the Z2 direction with respect to the surface 225a. In addition, any one of the surface 2721a and the surface 2722a may be located on the same plane as the surface 225a, and the other may be located in the Z1 direction or the Z2 direction with respect to the surface 225a. In other words, the surface 272a of the contact portion 272 may have a different portion in the Z1 direction from the surface 225a of the interlayer insulating film 225. In particular, the surface 272a may include a portion differs in position in the Z1 direction from a portion of the surface 225a that contacts the interlayer insulating film 226. Note that the same applies to the contact portion other than the contact portion 272. Furthermore, as described above, at least one of the plurality of contact portions included in the wiring layer 20 may be protruding or recessed with respect to a top surface of the corresponding interlayer insulating film. Not all of the contact portions need to satisfy the positional relationship with the interlayer insulating film as described above.

In the first embodiment, the contact portion 272 includes the first layer 2721 and the second layer 2722, but the contact portion 272 may include other than the first layer 2721 and the second layer 2722. For example, the contact portion 272 may be a single layer or may include three or more layers. For example, the contact portion 272 may include only the first layer 2721. Further, the material of the contact portion 272 is not limited to tungsten. For example, the material of the contact portion 272 may include a metal other than tungsten, such as aluminum and copper (Cu). Note that the other contact portions 271, 273, 274 and 275, the shield portion 270, and the like may also be formed of a material other than tungsten.

In the first embodiment, the number of the contact portion 272 coupled to one first capacitor 25 is one, but may be not less than two. The number of other contact portions 271, 273, 274 and 275, and the shield portion 270 may also be not less than two.

In the embodiment described above, a configuration in which the element substrate 2 has a “conductive portion” is described as an example, but the counter substrate 4 may have a “conductive portion”. One or both of the element substrate 2 and the counter substrate 4 may have a “conductive portion”.

In the embodiment described above, the storage capacitor 200 has the first capacitor 25 and the second capacitor 26, but one of the first capacitor 25 and the second capacitor 26 may be omitted. Furthermore, the stacking order of wirings included in the wiring layer 20 such as the scanning line 244, the first constant potential line 245, the data line 246, the second constant potential line 248, and the like is not limited to the example illustrated in FIG. 4, and is arbitrary. In addition, each of the first constant potential line 245 and the second constant potential line 248 functions as a capacitance line, but both or either may not function as a capacitance line.

In the embodiments described above, a case where a TFT is used as the transistor has been described as an example, but the transistor is not limited to a TFT, and may be, for example, a Metal-Oxide-Semiconductor Field-Effect Transistor (MOSFET) or the like.

In the embodiments described above, an active matrix driving electro-optical device 100 is illustrated, but the activation method of the electro-optical device may be a passive matrix driving method or the like, for example.

2. Electronic Apparatus

The electro-optical device 100 can be used for various electronic apparatuses.

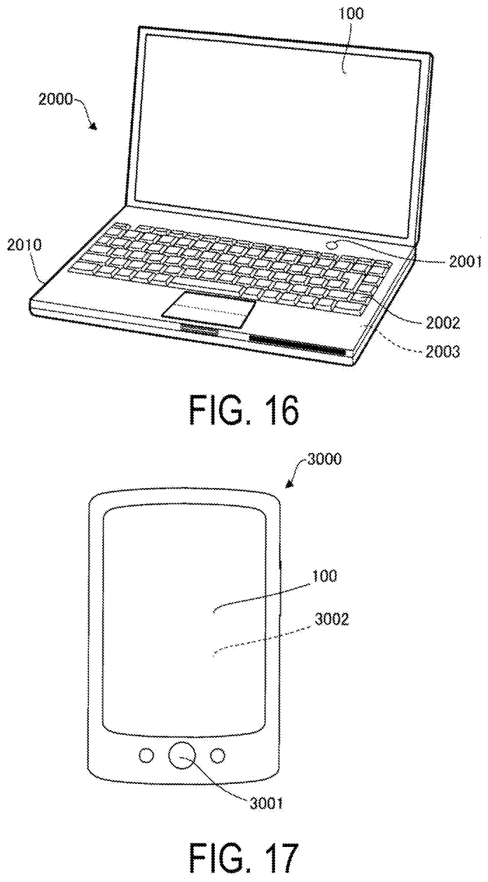

FIG. 16 is a perspective view illustrating a personal computer 2000 as an example of an electronic apparatus. The personal computer 2000 includes the electro-optical device 100 configured to display various images, a main body portion 2010 in which a power source switch 2001 and a keyboard 2002 are installed, and a control unit 2003. For example, the control unit 2003 includes a processor and a memory, to control the operation of the electro-optical device 100.

FIG. 17 is a perspective view illustrating a smart phone 3000 as an example of an electronic apparatus. The smartphone 3000 includes an operating button 3001, the electro-optical device 100 configured to display various images, and a control unit 3002. The screen content displayed on the electro-optical device 100 varies according to the operation of the operation button 3001. For example, the control unit 3002 includes a processor and a memory, to control the operation of the electro-optical device 100.

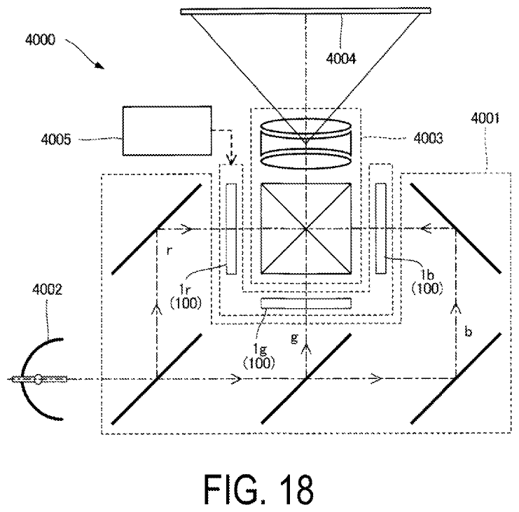

FIG. 18 is a schematic diagram illustrating a projector 4000 as an example of an electronic apparatus. The projection-type display device 4000 is a three-plate type projector, for example. An electro-optical device 1r is an electro-optical device 100 corresponding to a red display color, an electro-optical device 1g is an electro-optical device 100 corresponding to a green display color, and an electro-optical device 1b is an electro-optical device 100 corresponding to a blue display color. That is, the projection-type display device 4000 includes three electro-optical devices 1r, 1g, and 1b that respectively correspond to display colors of red, green, and blue. For example, a control unit 4005 includes a processor and a memory, to control the operation of the electro-optical device 100.

An illumination optical system 4001 supplies a red element r of light emitted from an illumination device 4002 as a light source to the electro-optical device 1r, a green element g of the light to the electro-optical device 1g, and a blue element b of the light to the electro-optical device 1b. Each of the electro-optical devices 1r, 1g, and 1b functions as an optical modulator, such as a light valve, that modulates respective rays of the monochromatic light supplied from the illumination optical system 4001 depending on display images. A projection optical system 4003 combines the rays of the light emitted from each of the electro-optical devices 1r, 1g, and 1b to project the combined light to a projection surface 4004.

The electronic apparatus includes the electro-optical device 100 described above, and the control unit 2003, 3002 or 4005. As described above, the electro-optical device 100 can achieve high definition while suppressing a decrease in characteristics. As a result, the display quality of the personal computer 2000, the smartphone 3000, or the projection-type display apparatus 4000 can be improved.

Note that, the electronic apparatus to which the electro-optical device according to the present disclosure is applied is not limited to the exemplified equipment, and include a PDA (Personal Digital Assistant), a digital still camera, a television, a video camera, a car navigation device, a display device for in-vehicle use, an electronic organizer, an electronic paper, an electronic calculator, a word processor, a workstation, a visual telephone, a POS (Point of sale) terminal, and the like. Furthermore, examples of the electronic apparatus to which the present disclosure is applied include a device a printer, a scanner, a copier, a video player, an apparatus including a touch panel, and the like.

The present disclosure have been described above based on the preferred embodiments, but the present disclosure is not limited to the embodiments described above. In addition, the configuration of each component of the present disclosure may be replaced with any configuration that exerts the equivalent functions of the embodiments described above, and to which any configuration may be added.

Further, in the above description, a liquid crystal device is described as an example of the electro-optical device of the present disclosure, but the electro-optical device of the present disclosure is not limited thereto. For example, the electro-optical device of the present disclosure can also be applied to an image sensor or the like. Further, for example, the present disclosure can also be applied to a display panel using light-emitting devices such as organic ElectroLuminescent (EL) devices, inorganic EL devices, and light-emitting polymers, similarly to the embodiments described above. Furthermore, the present disclosure can also be applied to an electrophoretic display panel that uses micro capsules each including colored liquid and white particles distributed in the liquid, similarly to the embodiments described above.

What is claimed is:

1. An electro-optical device comprising:
a substrate;
an electro-optical layer;
an insulating layer;
a conductive film disposed between the insulating layer and the electro-optical layer, and in contact with the insulating layer; and
a conductive portion provided at the insulating layer and coupled to the conductive film, wherein
the conductive portion overlaps the conductive film in plan view,
a surface of the conductive portion that is in contact with the conductive film is positioned at a first position in a thickness direction of the insulating layer, and
a surface of the insulating film that is in contact with the conductive film is positioned at a second position different from the first position in the thickness direction of the insulating layer.

2. The electro-optical device according to claim 1, wherein
the conductive film is a wiring.

3. The electro-optical device according to claim 1, wherein
the conductive film is a capacitive electrode.

4. The electro-optical device according to claim 1, wherein
a surface of the conductive film opposite to the insulating layer has a recess or a protrusion.

5. The electro-optical device according to claim 1, wherein
the conductive portion includes a first layer containing tungsten, and a second layer disposed between the first layer and the insulating layer and formed of a material different from the first layer.

6. The electro-optical device according to claim 5, wherein
a position of a surface of the first layer that is in contact with the conductive film and a position of a surface of the second layer that is in contact with the conductive film are different in the thickness direction.

7. The electro-optical device according to claim 1, further comprising:
a second conductive film that is provided on an opposite side of the insulating layer from the conductive film, and is a wiring or an electrode,
the conductive portion overlaps the second conductive film when viewed from the thickness direction and is coupled to the second conductive film.

8. The electro-optical device according to claim 1, wherein
the substrate includes a first substrate having a first pixel electrode and a second pixel electrode adjacent to the first pixel electrode, and a second substrate having a common electrode; and
the conductive portion is located between the first pixel electrode and the second pixel electrode in the plan view.

9. An electronic apparatus comprising:
the electro-optical device according to claim 1; and
a control unit configured to control operation of the electro-optical device.
